(19) United States
(12) Patent Application Publication
(10) Pub. No.: US 2015/0280559 A1
(43) Pub. Date: Oct. 1, 2015

(54) UNIFIED CONTROL SCHEME FOR NON-INVERTING HIGH-EFFICIENCY BUCK-BOOST POWER CONVERTERS

(71) Applicants: VAIBHAV VAIDYA, Portland, OR (US); HARISH K. KRISHNAMURTHY, Hillsboro, OR (US); TARUN MAHAJAN, Bangalore (IN)

(72) Inventors: VAIBHAV VAIDYA, Portland, OR (US); HARISH K. KRISHNAMURTHY, Hillsboro, OR (US); TARUN MAHAJAN, Bangalore (IN)

(21) Appl. No.: 14/229,856

(22) Filed: Mar. 29, 2014

(51) Int. Cl. H02M 3/158

(52) U.S. Cl. CPC H02M 3/158

(57) ABSTRACT

Methods and apparatus relating to a unified control scheme for non-inverting high-efficiency buck-boost power converters are described. In an embodiment, compensator logic causes a buck-boost power converter to provide an output voltage with a higher voltage level than an input voltage in a boost operational mode of the buck-boost power converter and to provide the output voltage with a lower voltage level than the input voltage in a buck operational mode of the buck-boost power converter. The compensator logic provides N+1 bits to Pulse Width Modulation (PWM) generator logic to cause the buck-boost power converter to provide the output voltage. One of the N+1 bits indicates whether the buck-boost power converter is to provide the buck operation or the boost operation. Other embodiments are also disclosed and claimed.

### FIELD

The present disclosure generally relates to the field of electronics. More particularly, an embodiment relates to a unified control scheme for non-inverting high-efficiency buck-boost power converters.

### BACKGROUND

Direct Current (DC) to DC power converters are generally used in power delivery applications in which an input voltage needs to be transformed to an output voltage in a ratio that can be both smaller and larger than unity. Such converters may be particularly relevant in battery powered portable electronics, where battery voltage can be either greater than or less than the required operating voltage for the electronics. Hence, efficient utilization of such power converters is paramount to proper operation of battery-powered devices.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1 and 10-12 illustrate block diagrams of embodiments of computing systems, which may be utilized to implement various embodiments discussed herein.

FIGS. 2A, 2B, 4B, and 8 illustrate circuit diagrams of buck and boost converters, according to some embodiments.

FIGS. 3, 4A, 5, and 9 illustrate graphs according to some embodiments.

FIGS. 6-7 illustrates block diagrams of digital control logic, according to some embodiments.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

As discussed above, DC-to-DC power converters may be used in power delivery applications that rely on battery power. One such converter is called a “buck-boost” power converter that is generally used in power delivery applications in which an input voltage needs to be transformed to an output voltage in a ratio that can be both smaller and larger than unity. Buck-boost converters are particularly relevant in battery powered portable electronics, where battery voltage can be either greater than or less than the required operating voltage for the electronics, e.g., depending on the state of charge of the battery.

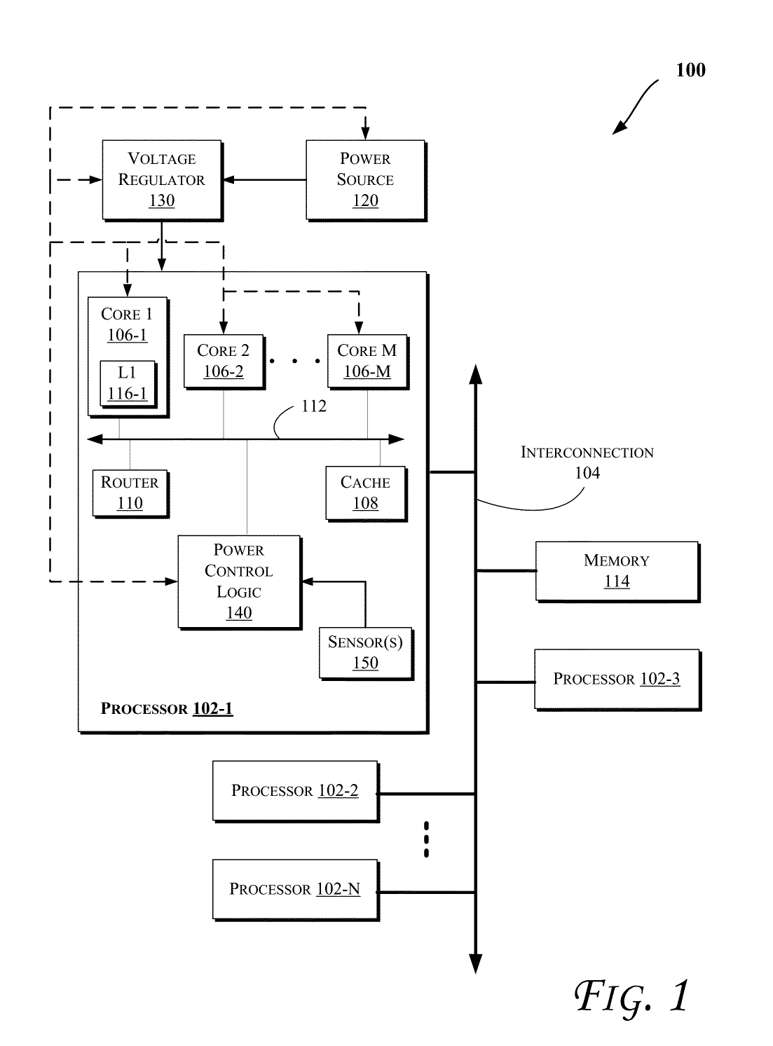

Some embodiments provide a unified control scheme for non-inverting high-efficiency buck-boost power converters. For example, a unified control scheme for both buck and boost modes of a buck-boost power converter may be provided (e.g., via logic 140 of FIG. 1) such that mode changes are seamless from a control standpoint. An embodiment provides a single compensator design for the entire operating range of the power converter, e.g., simplifying the design while providing robustness.

Moreover, some embodiments may be applied in computing systems that include one or more processors (e.g., with one or more processor cores), such as those discussed with reference to FIGS. 1-12, including for example mobile computing devices such as a smartphone, tablet, UMPC (Ultra-Mobile Personal Computer), laptop computer, Ultrabook™ computing device, smart watch, smart glasses, wearable devices, etc. More particularly, FIG. 1 illustrates a block diagram of a computing system 100, according to an embodiment. The system 100 may include one or more processors 102-1 through 102-N (generally referred to herein as “processors 102” or “processor 102”). The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

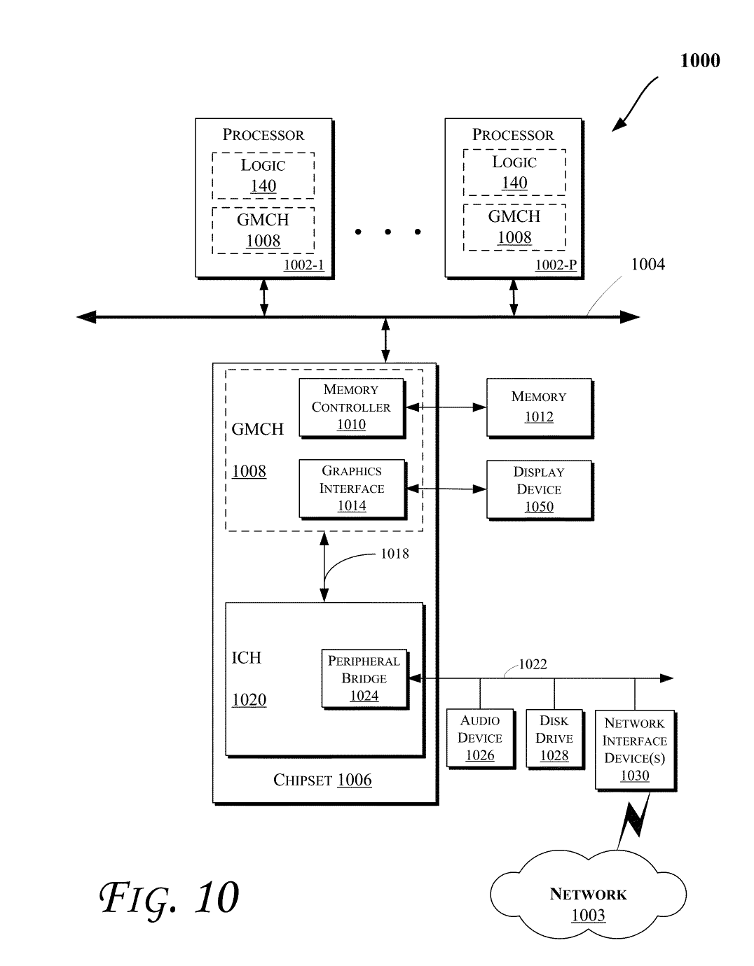

In an embodiment, the processor 102-1 may include one or more processor cores 106-1 through 106-M (referred to herein as “cores 106,” or “core 106”), a cache 108, and/or a router 110. The processor cores 106 may be implemented on a single integrated circuit (IC) chip. Moreover, the chip may include one or more shared and/or private caches (such as cache 108), buses or interconnections (such as a bus or interconnection 112), graphics and/or memory controllers (such as those discussed with reference to FIGS. 10-12), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that are utilized by one or more components of the processor 102-1, such as the cores 106. For example, the cache 108 may locally cache data stored in a memory 114 for faster access by the components of the processor 102 (e.g., faster access by cores 106). As shown in FIG. 1, the memory 114 may communicate with the processors 102 via the interconnection 104. In an embodiment, the cache 108 (that may be shared) may be a mid-level cache (MLC), a last level cache (LLC), etc. Also, each of the cores 106 may include a level 1 (L1) cache (116-1) (generally referred to herein as “L1 cache 116”) or other levels of cache such as a level 2 (L2) cache. Moreover, various components of the processor 102-1 may communicate with the cache 108 directly, through a bus (e.g., the bus 112), and/or a memory controller or hub.

The system 100 may also include a platform power source 120 (e.g., a direct current (DC) power source or an alternating current (AC) power source) to provide power to one or more components of the system 100. The power source 120 could include a PV (Photo Voltaic) panel, wind generator, thermal generator water/hydro turbine, etc. In some embodiments, the power source 120 may include one or more battery packs (e.g., charged by one or more of a PV panel, wind generator, thermal generator water/hydro turbine, plug-in power supply (e.g., coupled to an AC power grid), etc.) and/or plug-in power supplies. The power source 120 may be coupled to components of system 100 through a voltage regulator (VR) 130. Moreover, even though FIG. 1 illustrates one power source 120 and one voltage regulator 130, additional power sources and/or voltage regulators may be utilized. For example, one or more of the processors 102 may have corresponding voltage regulator(s) and/or power source(s). Also, the voltage regulator(s) 130 may be coupled to the processor 102 via a single power plane (e.g., supplying power to all the cores 106) or multiple power planes (e.g., where each power plane may supply power to a different core or group of cores).

Additionally, while FIG. 1 illustrates the power source 120 and the voltage regulator 130 as separate components, the power source 120 and the voltage regulator 130 may be incorporated into other components of system 100. For example, all or portions of the VR 130 may be incorporated into the power source 120 and/or processor 102.

As shown in FIG. 1, the processor 102 may further include a power control logic 140 to control supply of power to components of the processor 102 (e.g., cores 106). In an embodiment, logic 140 may provide a unified control scheme for non-inverting high-efficiency buck-boost power converters. Logic 140 may have access to one or more storage devices discussed herein (such as cache 108, L1 cache 116, memory 114, or another memory in system 100) to store information relating to operations of logic 140 such as information communicated with various components of system 100 as discussed here. As shown, the logic 140 may be coupled to the VR 130 and/or other components of system 100 such as the cores 106 and/or the power source 120.

Additionally, the logic 140 may be coupled to receive information (e.g., in the form of one or more bits or signals) to indicate status of one or more sensors 150. The sensor(s) 150 may be provided proximate to components of system 100 (or other computing systems discussed herein such as those discussed with reference to other figures including 10-12, for example), such as the cores 106, interconnections 104 or 112, components outside of the processor 102, etc., to sense variations in various factors affecting power/thermal behavior of the system/platform, such as temperature, operating frequency, operating voltage, power consumption, and/or inter-core communication activity, etc.

The logic 140 may in turn instruct the VR 130, power source 120, and/or individual components of system 100 (such as the cores 106) to modify their operations. For example, logic 140 may indicate to the VR 130 and/or power source 120 (or PSU) to adjust their output. In some embodiments, logic 140 may request the cores 106 to modify their operating frequency, power consumption, etc. Also, even though components 140 and 150 are shown to be included in processor 102-1, these components may be provided elsewhere in the system 100. For example, power control logic 140 may be provided in the VR 130, in the power source 120, directly coupled to the interconnection 104, within one or more (or alternatively all) of the processors 102, outside of computing device/system (e.g., as a standalone device), coupled to (or integrated with) the power source 120, etc. Furthermore, as shown in FIG. 1, the power source 120 and/or the voltage regulator 130 may communicate with the power control logic 140 and report their power specification. Hence, in an embodiment, logic 140 is an intelligent power controller with voltage translation, under-power and over-voltage protections.

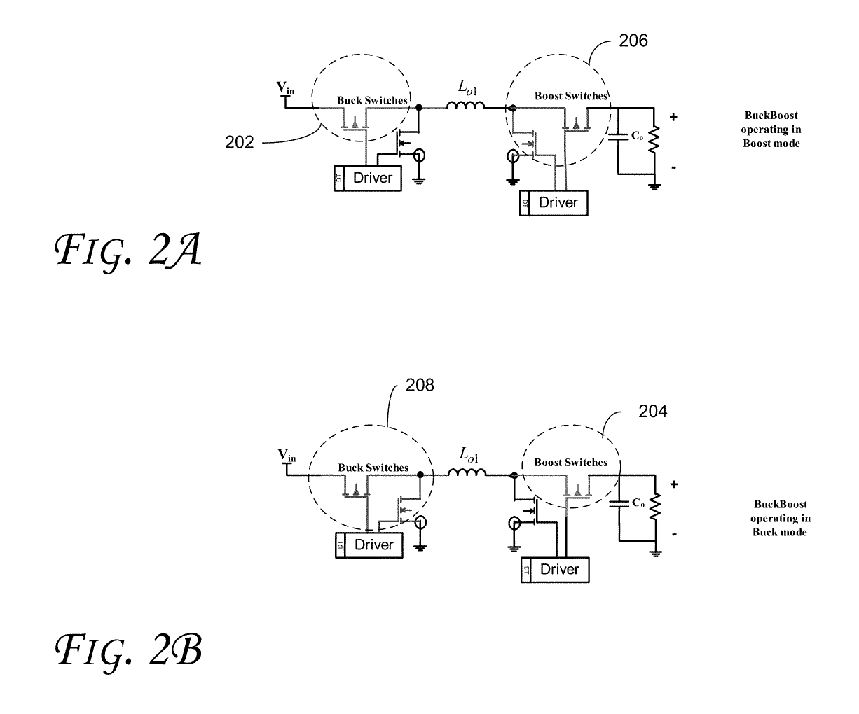

FIGS. 2A and 2B respectively illustrate circuit diagrams of buck and boost modes of a single-switched Buck-boost regulator, according to some embodiments. More particularly, one power efficient topology to implement buck-boost operations involves an LC filter (where “L” refers to inductor and “C” refers to capacitor). In FIGS. 2A and 2B, items 202 and 204 are completely on (static) and items 206 and 208 are cycled (or controlled), while the remaining circuit elements are completely off (or static). The LC filter uses buck and boost mode power switches independently of each other (with the same inductor). When the power transfer needs to have a reducing transformation ratio, the input side of the inductor is duty-cycled as in a buck converter (with the output always connected).

For over-unit ratios, the output side of the inductor is duty-cycled exclusively with the input always connected. This type of converter is referred to herein as a “single-switched” buck-boost converter. If all four FETs (Field-Effect Transistors) are switched instead, the converter is referred to as a “dual-switched” buck-boost converter. Control techniques for such a buck-boost topology (where only one end of the inductor is duty-cycled in a given switching cycle) are required to control both buck and boost modes with stability. Since buck and boost modes have different transfer functions, the control mechanism tends to be implemented as two separate compensators with a transition between buck and boost modes that may be managed by mode-switching mechanisms that may be heuristic. Alternatively, a small dual-switched buck-boost transition region may be introduced between exclusive buck and boost modes, e.g., by switching both sides of the inductor in a less power efficient buck-boost topology.

To this end, some embodiments provide a unified control scheme for non-inverting high-efficiency buck-boost power converters. For example, a unified control scheme for both buck and boost modes may be provided (e.g., via logic 140 of FIG. 1) such that mode-changes are seamless from a control standpoint. An embodiment provides a single compensator design for the entire operating range of the power converter, e.g., simplifying the design while providing robustness.

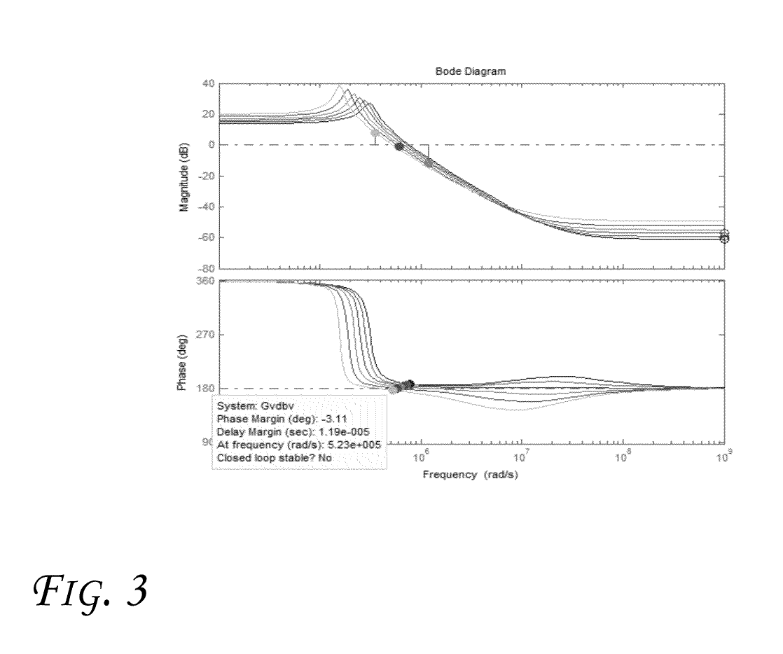

Moreover, such embodiments for control of the single-switched buck-boost converter proposes to ensure stability of the controller across operating points in both buck and boost modes, by designing compensation for the worst-case transfer function. To find the worst case, bode plots of transfer functions describing the buck and boost modes may be used such as illustrated in FIG. 3, according to an embodiment. However, other analysis methods and stability criteria such as state space averaging and/or Lyapunov criteria can also be used to find the worst-case operating point. In terms of bode plots, the minimum ‘gain-margin’ and ‘phase-margin’ denote the worst-case transfer function.

FIG. 3 illustrates Bode plots used to find the worst-case transfer function, according to an embodiment. More particularly, FIG. 3 illustrates a family of typical single-switched buck-boost transfer function bode plots showing variation with load and duty cycle in both buck and boost modes. Worst case phase margin is highlighted in FIG. 3. The controller (e.g., logic 140) may be designed to be stable for this worst case stability margin, and is thus guaranteed to be stable for the entire range of power conversion. Since a single compensator design is used in such an embodiment, the performance and speed of response of the controller are consistent across the entire range of operation. Mode-hopping logic to transition between buck and boost, and heuristics to ensure stability during the mode hops are no longer needed, and the power stage is operated at its maximum single-switched efficiency.

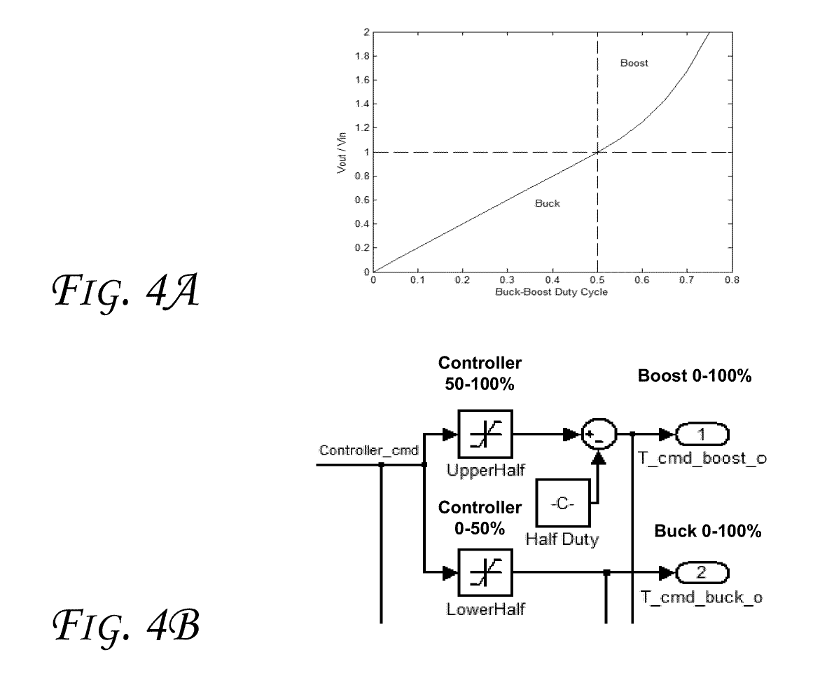

FIG. 4A illustrates a graph of gain variation of dual-switched buck-boost converter, according to an implementation. FIG. 4B illustrates a circuit diagram of a duty cycle division scheme for unified single-switched buck-boost control, according to an embodiment. With a single compensator design and avoidance of mode-hopping heuristics, a uniform transfer function for the converter can be obtained, e.g., similar to that of the traditional dual-switched buck-boost converter as shown in FIG. 4A. The duty cycle from the unified controller is split into buck and boost as shown in FIG. 4B. In the figure, the controller_cmd is the unified duty cycle command from the controller, ranging from 0%-200%. The lowerhalf block's output goes from 0-100% when controller_cmd goes from 0-100%, saturating to 100% for controller_cmd greater than 100%, while the upperhalf block's output goes from 100%-200% when the controller_cmd goes from 100%-200%, saturating to 100% when controller_cmd is lower than 100%. The Half Duty block subtracts 100% from the output of upperhalf, giving a range of 0-100% to the T_cmd_boost_output, which controls the boost mode duty cycle. The lowerhalf block's output goes directly to T_cmd_buck_output, which controls the buck mode duty cycle.

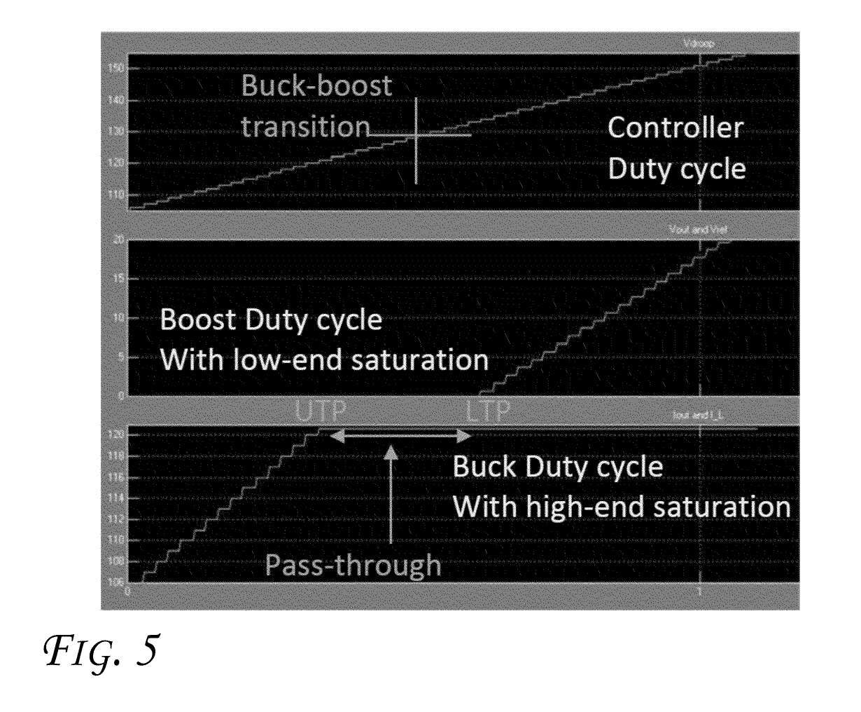

In a practical buck-boost converter, both the buck-side switches and boost-side switches of FIG. 2 have a dead-time between their ‘ON’ cycles, to prevent shorting the input or output to ground. Further, the drive circuits for the switches have a finite response-time, limiting the pulse-width of PWM (Pulse Width Modulation) pulses that they can drive on both the high end (close to 100% pulse-width) and the low end (close to 0% pulse-width). What this implies is that practically the buck and boost pulse-widths are limited to a range of typically 5% to 95% each. Thus, when the controller attempts to transition duty cycle smoothly between buck and boost modes around the 0.5 duty cycle mark (e.g., switching from 100% buck to 0% boost or back), the actual transition happens from 95% buck to 5% boost. To handle this discontinuity gracefully without interruptions in inductor current flow, in the region around 0.5 buck-boost duty cycle, (from say 0.475 to 0.525 which corresponds to the 5% and 95% limits), the buck and boost may be maintained at 100% and 0% duty cycle respectively, turning on their respective high-side switches. This region is termed the ‘pass-through’ region, as the inductor is simply connected from the input to the output voltage. Duty cycle saturation in buck and boost modes during the mode switch is illustrated in FIG. 5. A large pass-through region can lead to instability with the controller unable to compensate for the lack of response from the power stages. Some power stages may only have a 5% pass-through region, which is sufficient for stable operation.

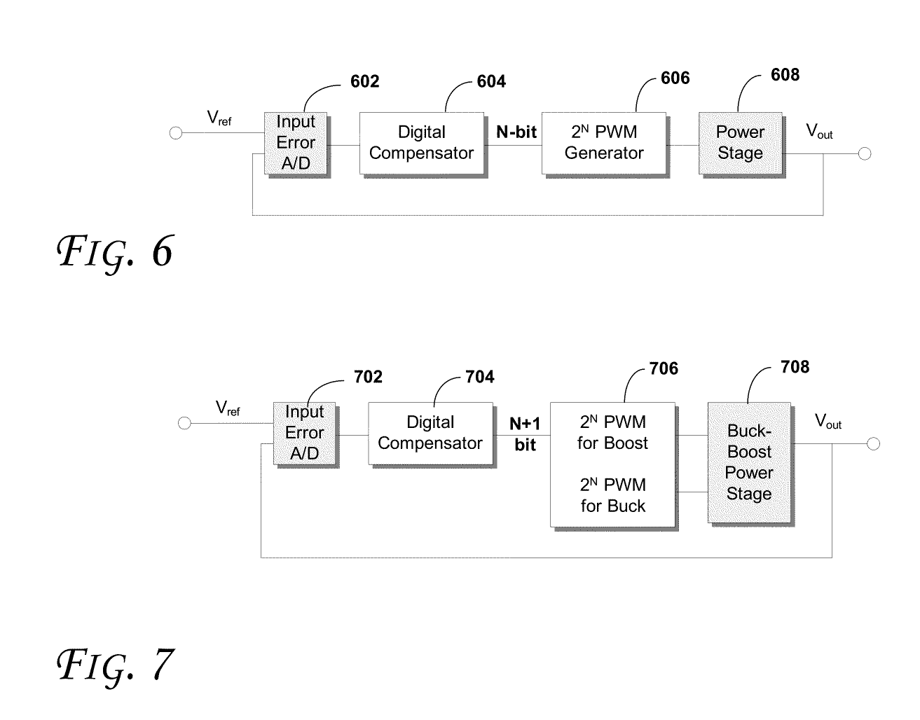

FIG. 6 illustrates a block diagram of digital control scheme, according to an embodiment. Some embodiments discussed herein lend themselves to a particularly elegant implementation in the digital domain. In a single buck or boost controller (such as logic 140), an N-bit duty cycle maps to 2^{N} states that the controller can resolve using its compensator arithmetic.

Referring to FIG. 6 (which illustrates components of logic 140 in an embodiment), considering the same PWM resolution for buck and boost domains, we have 2^{N} states for the buck mode, followed by 2^{N} states for the boost mode. To control the entire buck-boost range (FIG. 4A), the controller needs to resolve 2^{N}+2^{N}=2^{N+1} states. In the traditional implementation with separate buck and boost controllers, the area and power overhead of the controllers could be prohibitive irrespective of either analog or digital control. In one embodiment, both the controller and the PWM generation logic can be minimized to allow seamless transition between buck and boost modes. As shown in FIG. 6, a reference voltage (Vref) is compared with the output voltage to generate an input error in the A/D (Analog to Digital) converter logic 602, which is sent to a digital compensator logic 604 which processes the error and controls the dynamic response of the converter including its mode of operation (buck, pass-through or boost) by generating a duty cycle signal, which is processed by a PWM generator logic 606 to generate switching control signals for the power stage logic 608 which contains transistor(s) or other switches and an LC filter which sees a switching waveform between input voltage and ground voltage (e.g., with a ratio equal to the duty cycle or 1-duty cycle) generated by the compensator logic 604. The LC filter within the power stage then generates the output voltage (Vout).

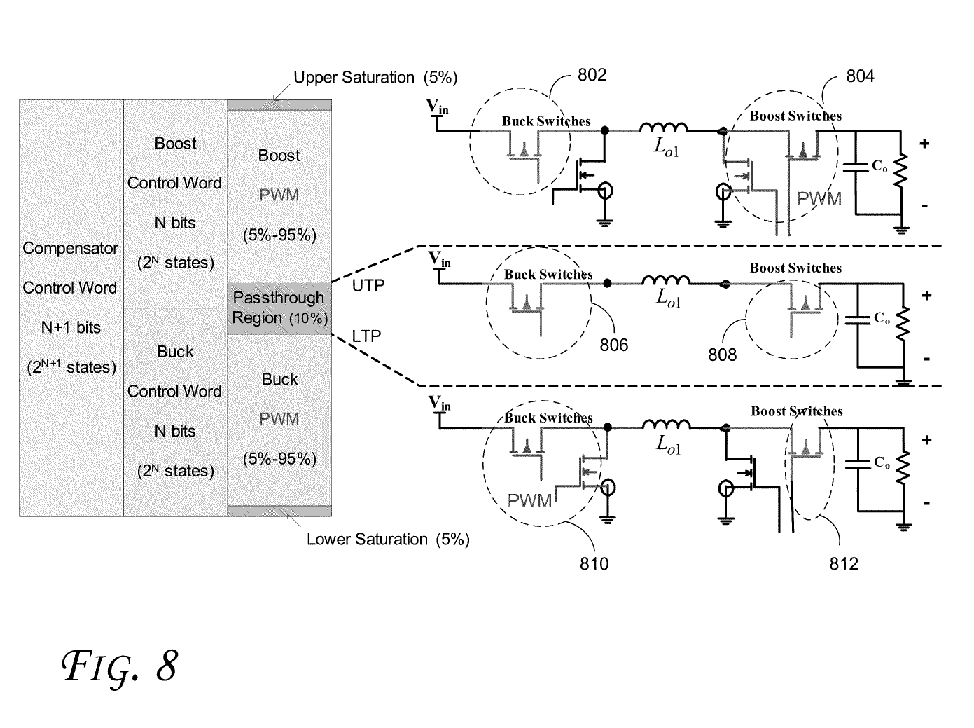

Furthermore, with a unified control scheme, the controller simply needs to add 1 bit to its control word as shown on the right hand side of the equation and in FIGS. 7 and 8 (which respectively illustrate a block diagram of a unified buck-boost converter with digital control and buck-boost operations, according to some embodiments). In FIG. 8, items 802, 806, 808, and 812 are completely on (static) and items 804 and 810 are cycled (or controlled), while the remaining circuit elements are completely off (or static). The MSB (Most Significant Bit) in a unified controller may be used to determine between buck and boost operations, whereas the rest of the N-bit control word may be common to either buck, or boost mode. FIG. 4B illustrates the logic capable of decoding the controller command into buck and boost PWM commands. This approach is more efficient in terms of power and area of the digital controller, and a major improvement provided by such embodiments. As shown in FIG. 7, a reference voltage (Vref) is received an input error A/D converter logic 702, which is sent to a digital compensator logic 704, followed by a buck-boost PWM generator logic 706 and a buck-boost power stage logic 708. The power stage logic 708 then generates the output voltage (Vout).

Also, although the MSB can switch the controller between buck and boost modes, the actual PWM presented to the buck and boost switches may take the pass-through region into account. To ensure smooth pass-through, the buck-boost PWM region may be divided into three regions, with transition points between them. This is illustrated in FIGS. 8 and 5. When the buck duty cycle reaches a predefined maximum, known as the Upper Trigger Point (UTP), the duty cycle is saturated; similarly when the boost duty cycle reaches a predefined minimum, known as the Lower Trigger Point (LTP), the pass-through condition is activated.

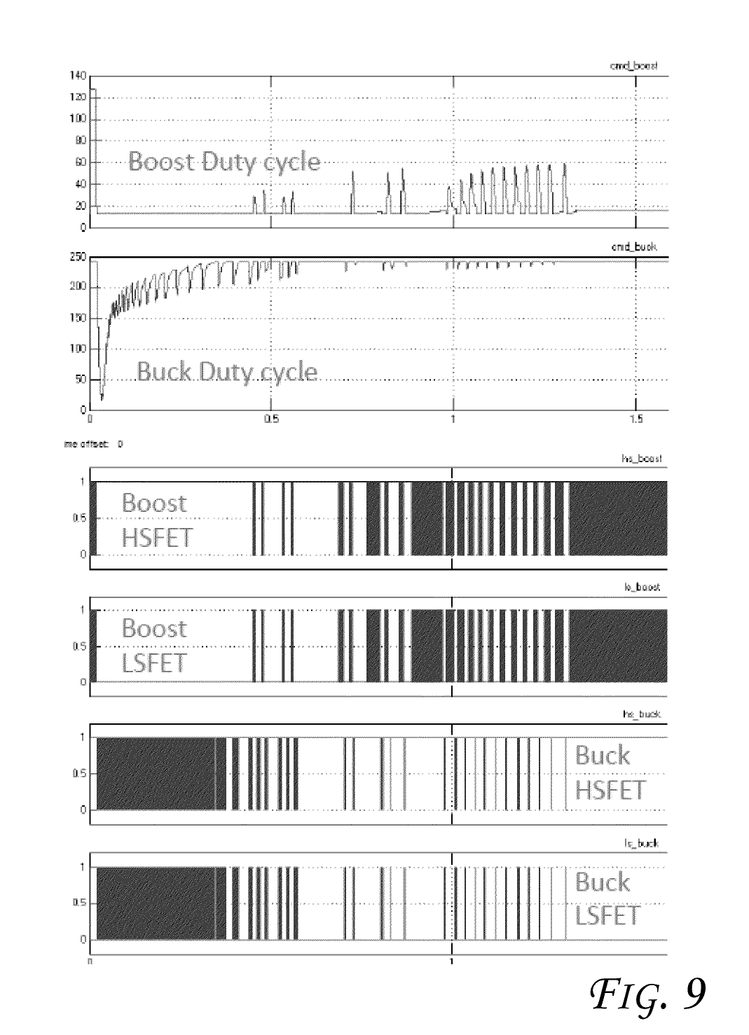

FIG. 9 depicts sample simulation results of the closed loop operation of a unified buck-boost controller, according to some embodiments. More particularly, FIG. 9 shows duty cycle ramp-up from controller and resulting buck and boost PWM pulses. As shown, the controller duty cycle around the 50% mark gets split between buck and boost duty cycles. As the controller attempts to find an operating point around the pass-through region, both buck and boost pulses occur. When the operating points are clearly in the buck or boost regions, only the corresponding buck or boost pulses occur. This illustrates the transition between buck and boost modes as the controller operating point is raised.

Accordingly, some embodiments with a unified single-switched buck-boost have significant advantages over both a double-switched converter and a single-switched converter with a dual compensator design, including: (1) The area and power overhead of the digital controller can be reduced by almost half compared to a traditional dual-compensator design. In a digital controller, only one additional bit over the inherent PWM resolution is used in the controller output to enable buck-boost operation; (2) A single controller logic block can be designed using such techniques that handles buck, boost and buck-boost power stages by changing parameters of the compensator, which yields time-to-market improvements in product families with different types of converters; (3) By designing the controller with the worst-case transfer function, a stable and robust operation can be achieved; (4) mode-hopping heuristics can be avoided; and/or (5) Such techniques can improve both, analog and digital controllers by simplifying their design and providing a robust design paradigm.

FIG. 10 illustrates a block diagram of a computing system 1000 in accordance with an embodiment. The computing system 1000 may include one or more central processing unit(s) (CPUs) or processors 1002-1 through 1002-P (which may be referred to herein as “processors 1002” or “processor 1002”). The processors 1002 may communicate via an interconnection network (or bus) 1004. The processors 1002 may include a general purpose processor, a network processor (that processes data communicated over a computer network 1003), or other types of a processor (including a reduced instruction set computer (RISC) processor or a complex instruction set computer (CISC)). Moreover, the processors 1002 may have a single or multiple core design. The processors 1002 with a multiple core design may integrate different types of processor cores on the same integrated circuit (IC) die. Also, the processors 1002 with a multiple core design may be implemented as symmetrical or asymmetrical multiprocessors. In an embodiment, one or more of the processors 1002 may be the same or similar to the processors 102 of FIG. 1. In some embodiments, one or more of the processors 1002 may include one or more of the cores 106, logic 140, and sensor(s) 150, of FIG. 1. Also, the operations discussed with reference to FIGS. 1-9 may be performed by one or more components of the system 1000. For example, a voltage regulator (such as VR 130 of FIG. 1) may regulate voltage supplied to one or more components of FIG. 10 at the direction of logic 140.

A chipset 1006 may also communicate with the interconnection network 1004. The chipset 1006 may include a graphics and memory control hub (GMCH) 1008. The GMCH 1008 may include a memory controller 1010 that communicates with a memory 1012. The memory 1012 may store data, including sequences of instructions that are executed by the processor 1002, or any other device included in the computing system 1000. In one embodiment, the memory 1012 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 1004, such as multiple CPUs and/or multiple system memories.

The GMCH 1008 may also include a graphics interface 1014 that communicates with a display device 1050, e.g., a graphics accelerator. In one embodiment, the graphics interface 1014 may communicate with the display device 1050 via an accelerated graphics port (AGP) or Peripheral Component Interconnect (PCI) (or PCI express (PCIe) interface). In an embodiment, the display device 1050 (such as a flat panel display (such as an LCD (Liquid Crystal Display), a cathode ray tube (CRT), a projection screen, etc.) may communicate with the graphics interface 1014 through, for example, a signal converter that translates a digital representation of an image stored in a storage device such as video memory or system memory into display signals that are interpreted and displayed by the display. The display signals produced may pass through various control devices before being interpreted by and subsequently displayed on the display device 1050.

A hub interface 1018 may allow the GMCH 1008 and an input/output control hub (ICH) 1020 to communicate. The ICH 1020 may provide an interface to I/O devices that communicate with the computing system 1000. The ICH 1020 may communicate with a bus 1022 through a peripheral bridge (or controller) 1024, such as a peripheral component interconnect (PCI) bridge, a universal serial bus (USB) controller, or other types of peripheral bridges or controllers. The bridge 1024 may provide a data path between the processor 1002 and peripheral devices. Other types of topologies may be utilized. Also, multiple buses may communicate with the ICH 1020, e.g., through multiple bridges or controllers. Moreover, other peripherals in communication with the ICH 1020 may include, in various embodiments, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 1022 may communicate with an audio device 1026, one or more disk drive(s) 1028, and one or more network interface device(s) 1030 (which is in communication with the computer network 1003). Other devices may communicate via the bus 1022. Also, various components (such as the network interface device 1030) may communicate with the GMCH 1008 in some embodiments. In addition, the processor 1002 and the GMCH 1008 may be combined to form a single chip. Furthermore, the graphics accelerator may be included within the GMCH 1008 in other embodiments.

Furthermore, the computing system 1000 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 1028), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 1000 may be arranged in a point-to-point (PtP) configuration. For example, processors, memory, and/or input/output devices may be interconnected by a number of point-to-point interfaces.

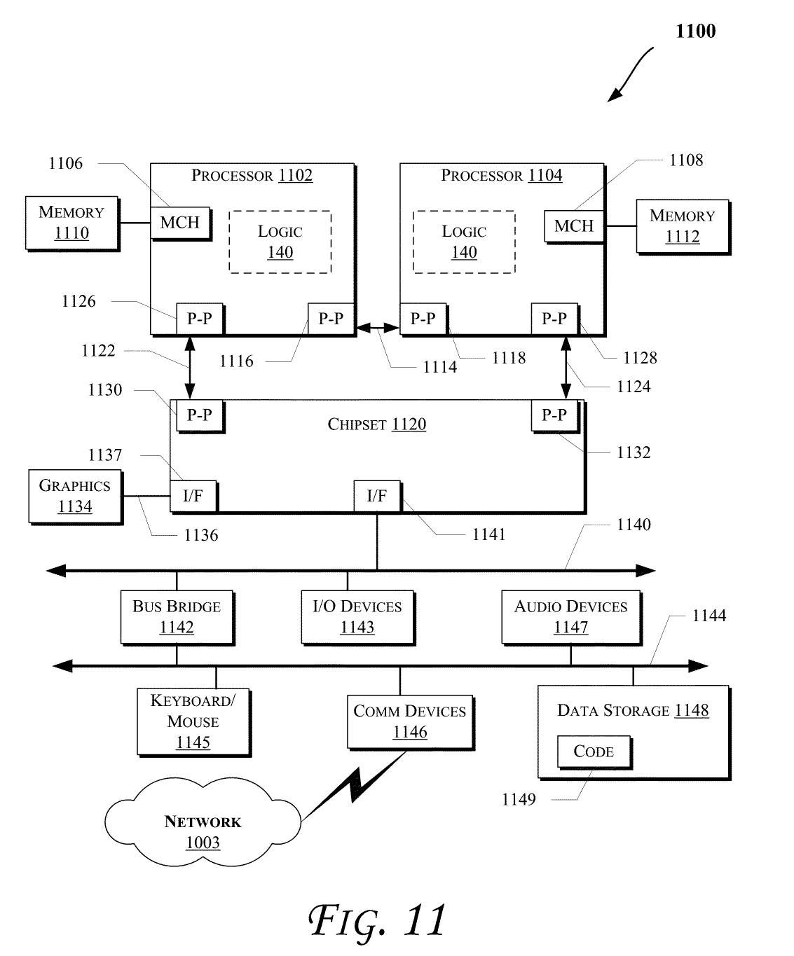

FIG. 11 illustrates a computing system 1100 that is arranged in a point-to-point (PtP) configuration, according to an embodiment. In particular, FIG. 11 shows a system where processors, memory, and input/output devices are interconnected by a number of point-to-point interfaces. The operations discussed with reference to FIGS. 1-10 may be performed by one or more components of the system 1100. For example, a voltage regulator (such as VR 130 of FIG. 1) may regulate voltage supplied to one or more components of FIG. 11.

As illustrated in FIG. 11, the system 1100 may include several processors, of which only two, processors 1102 and 1104 are shown for clarity. The processors 1102 and 1104 may each include a local memory controller hub (MCH) 1106 and 1108 to enable communication with memories 1110 and 1112. The memories 1110 and/or 1112 may store various data such as those discussed with reference to the memory 1012 of FIG. 10. Also, the processors 1102 and 1104 may include one or more of the cores 106, logic 140, and/or sensor(s) 150 of FIG. 1.

In an embodiment, the processors 1102 and 1104 may be one of the processors 1002 discussed with reference to FIG. 10. The processors 1102 and 1104 may exchange data via a point-to-point (PtP) interface 1114 using PtP interface circuits 1116 and 1118, respectively. Also, the processors 1102 and 1104 may each exchange data with a chipset 1120 via individual PtP interfaces 1122 and 1124 using point-to-point interface circuits 1126, 1128, 1130, and 1132. The chipset 1120 may further exchange data with a high-performance graphics circuit 1134 via a high-performance graphics interface 1136, e.g., using a PtP interface circuit 1137.

In at least one embodiment, one or more operations discussed with reference to FIGS. 1-10 may be performed by the processors 1102 or 1104 and/or other components of the system 1100 such as those communicating via a bus 1140. Other embodiments, however, may exist in other circuits, logic units, or devices within the system 1100 of FIG. 11. Furthermore, some embodiments may be distributed throughout several circuits, logic units, or devices illustrated in FIG. 11.

Chipset 1120 may communicate with the bus 1140 using a PtP interface circuit 1141. The bus 1140 may have one or more devices that communicate with it, such as a bus bridge 1142 and I/O devices 1143. Via a bus 1144, the bus bridge 1142 may communicate with other devices such as a keyboard/mouse 1145, communication devices 1146 (such as modems, network interface devices, or other communication devices that may communicate with the computer network 1003), audio I/O device, and/or a data storage device 1148. The data storage device 1148 may store code 1149 that may be executed by the processors 1102 and/or 1104.

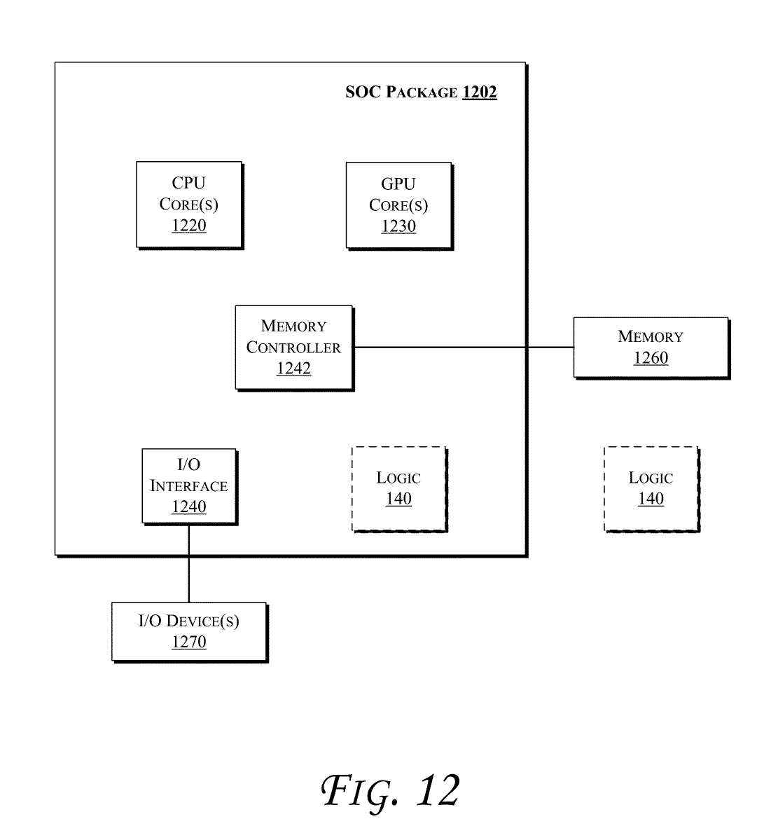

In some embodiments, one or more of the components discussed herein can be embodied as a System On Chip (SOC) device. FIG. 12 illustrates a block diagram of an SOC package in accordance with an embodiment. As illustrated in FIG. 12, SOC 1202 includes one or more Central Processing Unit (CPU) cores 1220, one or more Graphics Processor Unit (GPU) cores 1230, an Input/Output (I/O) interface 1240, and a memory controller 1242. Various components of the SOC package 1202 may be coupled to an interconnect or bus such as discussed herein with reference to the other figures. Also, the SOC package 1202 may include more or less components, such as those discussed herein with reference to the other figures. Further, each component of the SOC package 1220 may include one or more other components, e.g., as discussed with reference to the other figures herein. In one embodiment, SOC package 1202 (and its components) is provided on one or more Integrated Circuit (IC) die, e.g., which are packaged into a single semiconductor device.

As illustrated in FIG. 12, SOC package 1202 is coupled to a memory 1260 (which may be similar to or the same as memory discussed herein with reference to the other figures) via the memory controller 1242. In an embodiment, the memory 1260 (or a portion of it) can be integrated on the SOC package 1202.

The I/O interface 1240 may be coupled to one or more I/O devices 1270, e.g., via an interconnect and/or bus such as discussed herein with reference to other figures. I/O device(s) 1270 may include one or more of a keyboard, a mouse, a touchpad, a display, an image/video capture device (such as a camera or camcorder/video recorder), a touch screen, a speaker, or the like. Furthermore, SOC package 1202 may include/integrate the logic 140 in an embodiment. Alternatively, the logic 140 may be provided outside of the SOC package 1202 (i.e., as a discrete logic).

The following examples pertain to further embodiments. Example 1 includes an apparatus comprising: compensator logic, at least a portion of which is in hardware, to cause a buck-boost power converter to provide an output voltage with a higher voltage level than an input voltage in a boost operational mode of the buck-boost power converter and to provide the output voltage with a lower voltage level than the input voltage in a buck operational mode of the buck-boost power converter, wherein the compensator logic is to provide N+1 bits to Pulse Width Modulation (PWM) generator logic to cause the buck-boost power converter to provide the output voltage, wherein one of the N+1 bits is to indicate whether the buck-boost power converter is to provide the buck operation or the boost operation. Example 2 includes the apparatus of example 1, wherein each of the buck operational mode or the boost operational mode include N operational voltage levels. Example 3 includes the apparatus of example 1, wherein the buck-boost power converter is to comprise a single-switched buck-boost power converter. Example 4 includes the apparatus of example 1, wherein the compensator logic is to operate in accordance with a worst case transfer function. Example 5 includes the apparatus of example 4, wherein the worst case transfer function is to be determined based on one or more bode plots. Example 6 includes the apparatus of example 5, wherein the worst case transfer function is to be determined based on one or more of: a minimum gain margin and a phase margin of the one or more bode plots. Example 7 includes the apparatus of example 4, wherein the worst case transfer function is to be determined based on one or more of state space averaging and a Lyapunov criteria. Example 8 includes the apparatus of example 1, further comprising one or more sensors, coupled to the logic, wherein the one or more sensors are to detect variations in one or more of: temperature, operating frequency, operating voltage, and power consumption. Example 9 includes the apparatus of example 1, wherein one or more of: the logic, a processor, and memory are on a single integrated circuit.

Example 10 includes a method comprising: causing, at a compensator logic, a buck-boost power converter to provide an output voltage with a higher voltage level than an input voltage in a boost operational mode of the buck-boost power converter and to provide the output voltage with a lower voltage level than the input voltage in a buck operational mode of the buck-boost power converter, wherein the compensator logic provides N+1 bits to Pulse Width Modulation (PWM) generator logic to cause the buck-boost power converter to provide the output voltage, wherein one of the N+1 bits indicates whether the buck-boost power converter is to provide the buck operation or the boost operation. Example 11 includes the method of example 10, wherein each of the buck operational mode or the boost operational mode include N operational voltage levels. Example 12 includes the method of example 10, wherein the buck-boost power converter is a single-switched buck-boost power converter. Example 13 includes the method of example 10, further comprising operating the compensator logic in accordance with a worst case transfer function. Example 14 includes the method of example 13, further comprising determining the worst case transfer function based on one or more bode plots. Example 15 includes the method of example 14, further comprising determining the worst case transfer function based on one or more of: a minimum gain margin and a phase margin of the one or more bode plots. Example 16 includes the method of example 13, further comprising determining the worst case transfer function based on one or more of state space averaging and a Lyapunov criteria. Example 17 includes the method of example 10, further comprising one or more sensors detecting variations in one or more of: temperature, operating frequency, operating voltage, and power consumption.

Example 18 includes a system comprising: a processor having one or more processor cores; compensator logic to cause a buck-boost power converter to provide an output voltage with a higher voltage level than an input voltage in a boost operational mode of the buck-boost power converter and to provide the output voltage with a lower voltage level than the input voltage in a buck operational mode of the buck-boost power converter, wherein the compensator logic is to provide N+1 bits to Pulse Width Modulation (PWM) generator logic to cause the buck-boost power converter to provide the output voltage, wherein one of the N+1 bits is to indicate whether the buck-boost power converter is to provide the buck operation or the boost operation. Example 19 includes the system of example 18, wherein each of the buck operational mode or the boost operational mode include N operational voltage levels. Example 20 includes the system of example 18, wherein the buck-boost power converter is to comprise a single-switched buck-boost power converter. Example 21 includes the system of example 18, wherein the compensator logic is to operate in accordance with a worst case transfer function. Example 22 includes the system of example 21, wherein the worst case transfer function is to be determined based on one or more bode plots. Example 23 includes the system of example 21, wherein the worst case transfer function is to be determined based on one or more of state space averaging and a Lyapunov criteria. Example 24 includes the system of example 18, further comprising one or more sensors, coupled to the logic, wherein the one or more sensors are to detect variations in one or more of: temperature, operating frequency, operating voltage, and power consumption. Example 25 includes the system of example 18, wherein one or more of: the logic, a processor, and memory are on a single integrated circuit. Example 26 includes the system of example 18, wherein one or more of: the logic, the processor, and memory are on a single integrated circuit.

Example 27 includes the system of example 18, further comprising one or more battery packs to supply power to the logic.

Example 28 includes a machine readable medium including code, when executed, to cause a machine to perform the method of any one of examples 10 to 17.

Example 29 includes an apparatus comprising means to perform a method as set forth in any one of examples 10 to 17.

Example 30 includes an apparatus comprising means to perform a method as set forth in any preceding example.

Example 31 a machine-readable storage including machine-readable instructions, when executed, to implement a method or realize an apparatus as set forth in any preceding claim.

In various embodiments, the operations discussed herein, e.g., with reference to FIGS. 1-12, may be implemented as hardware (e.g., logic circuitry), software, firmware, or combinations thereof, which may be provided as a computer program product, e.g., including a tangible machine-readable or computer-readable medium having stored thereon instructions (or software procedures) used to program a computer to perform a process discussed herein. The machine-readable medium may include a storage device such as those discussed with respect to FIGS. 1-12.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
compensator logic, at least a portion of which is in hardware, to cause a buck-boost power converter to provide an output voltage with a higher voltage level than an input voltage in a boost operational mode of the buck-boost power converter and to provide the output voltage with a lower voltage level than the input voltage in a buck operational mode of the buck-boost power converter,
wherein the compensator logic is to provide N+1 bits to Pulse Width Modulation (PWM) generator logic to cause the buck-boost power converter to provide the output voltage, wherein one of the N+1 bits is to indicate whether the buck-boost power converter is to provide the buck operation or the boost operation.

2. The apparatus of claim 1, wherein each of the buck operational mode or the boost operational mode include N operational voltage levels.

3. The apparatus of claim 1, wherein the buck-boost power converter is to comprise a single-switched buck-boost power converter.

4. The apparatus of claim 1, wherein the compensator logic is to operate in accordance with a worst case transfer function.

5. The apparatus of claim 4, wherein the worst case transfer function is to be determined based on one or more bode plots.

6. The apparatus of claim 5, wherein the worst case transfer function is to be determined based on one or more of: a minimum gain margin and a phase margin of the one or more bode plots.

7. The apparatus of claim 4, wherein the worst case transfer function is to be determined based on one or more of state space averaging and a Lyapunov criteria.

8. The apparatus of claim 1, further comprising one or more sensors, coupled to the logic, wherein the one or more sensors are to detect variations in one or more of:
temperature, operating frequency, operating voltage, and power consumption.

9. The apparatus of claim 1, wherein one or more of: the logic, a processor, and memory are on a single integrated circuit.

10. A method comprising:
causing, at a compensator logic, a buck-boost power converter to provide an output voltage with a higher voltage level than an input voltage in a boost operational mode of the buck-boost power converter and to provide the output voltage with a lower voltage level than the input voltage in a buck operational mode of the buck-boost power converter,
wherein the compensator logic provides N+1 bits to Pulse Width Modulation (PWM) generator logic to cause the buck-boost power converter to provide the output voltage, wherein one of the N+1 bits indicates whether the buck-boost power converter is to provide the buck operation or the boost operation.

11. The method of claim 10, wherein each of the buck operational mode or the boost operational mode include N operational voltage levels.

12. The method of claim 10, wherein the buck-boost power converter is a single-switched buck-boost power converter.

13. The method of claim 10, further comprising operating the compensator logic in accordance with a worst case transfer function.

14. The method of claim 13, further comprising determining the worst case transfer function based on one or more bode plots.

15. The method of claim 14, further comprising determining the worst case transfer function based on one or more of: a minimum gain margin and a phase margin of the one or more bode plots.

16. The method of claim 13, further comprising determining the worst case transfer function based on one or more of state space averaging and a Lyapunov criteria.

17. The method of claim 10, further comprising one or more sensors detecting variations in one or more of: temperature, operating frequency, operating voltage, and power consumption.

18. A system comprising:
a processor having one or more processor cores;
compensator logic to cause a buck-boost power converter to provide an output voltage with a higher voltage level than an input voltage in a boost operational mode of the buck-boost power converter and to provide the output voltage with a lower voltage level than the input voltage in a buck operational mode of the buck-boost power converter,
wherein the compensator logic is to provide N+1 bits to Pulse Width Modulation (PWM) generator logic to cause the buck-boost power converter to provide the output voltage, wherein one of the N+1 bits is to indicate whether the buck-boost power converter is to provide the buck operation or the boost operation.

19. The system of claim 18, wherein each of the buck operational mode or the boost operational mode include N operational voltage levels.

20. The system of claim 18, wherein the buck-boost power converter is to comprise a single-switched buck-boost power converter.

21. The system of claim 18, wherein the compensator logic is to operate in accordance with a worst case transfer function.

22. The system of claim 21, wherein the worst case transfer function is to be determined based on one or more bode plots.

23. The system of claim 21, wherein the worst case transfer function is to be determined based on one or more of state space averaging and a Lyapunov criteria.

24. The system of claim 18, further comprising one or more sensors, coupled to the logic, wherein the one or more sensors are to detect variations in one or more of: temperature, operating frequency, operating voltage, and power consumption.

25. The system of claim 18, wherein one or more of: the logic, a processor, and memory are on a single integrated circuit.
